(19) United States
(12) Patent Application Publication
(10) Pub. No.: US 2014/0363064 A1
(43) Pub. Date: Dec. 11, 2014

(54) COMPUTATIONAL METHODS AND APPARATUS FOR MEIBOGRAPHY

(71) Applicants: AGENCY FOR SCIENCE, TECHNOLOGY AND RESEARCH, Singapore (SG); SINGAPORE HEALTH SERVICES PTE LTD., Singapore (SG)

(72) Inventors: Hwee Kuan Lee, Singapore (SG); Patrick Koh, Singapore (SG); Turgay Celik, Singapore (SG); Louis Hak Tien Tong, Singapore (SG); Andrea Petznick, Singapore (SG)

(21) Appl. No.: 14/373,024

(22) PCT Filed: Jan. 18, 2013
(86) PCT No.: PCT/SG2013/000026

§ 371 Date: Jul. 17, 2014

(30) Foreign Application Priority Data
Jan. 18, 2012 (SG) 201200410.7

(51) Int. Cl. G06T 7/00; G06K 9/62; G06K 9/46

(52) U.S. Cl. CPC G06T 7/0012; G06K 9/46; G06K 9/62; G06T 2207/30041
USPC 382/128

(57) ABSTRACT

An occular image of a region including meibomian glands is processed automatically. The processing may derive a grade indicative of the health of the meibomian glands, by using in the occular image to obtain one or more numerical parameters characterizing the meibomian glands shown in the occular image, and determining the grade using the one or more numerical parameters. The numerical parameters include a parameter characterizing the diversity between scale parameters of significant features of the image obtained by a scale-space transform, and/or parameters obtained by measurement of lines in the occular image representing respective glands. Meibomian glands can be identified on ocular images using Gabor filtering as a local filtering technique. The parametrization in shape, local spatial support, and orientation of Gabor filtering is particularly suitable for detecting meibomian glands.

### FIELD OF THE INVENTION

The present invention relates to computational methods and apparatus for processing images of the meibomian glands to derive information characterizing abnormalities in the glands, indicative of medical conditions.

### BACKGROUND OF THE INVENTION

The meibomian glands are sebaceous glands at the rim of the eyelids inside the tarsal plate, responsible for the supply of meibum, an oily substance that prevents evaporation of the eye's tear film. Meibum is a lipid which prevents tear spillage onto the cheek, trapping tears between the oiled edge and the eyeball, and makes the closed lids airtight. It further covers the tear surface, and prevents water in the tears from evaporating too quickly. Dysfunctional meibomian glands can cause dry eyes (since without this lipid, water in the eye evaporates too quickly) or blepharitis; and other medical conditions.

It is known to capture infra-red (IR) images of ocular surface to analyse the morphological structures of the meibomian glands. For an healthy eye, the glands have similar features in terms of spatial width, in-plane elongation, length, etc. On the other hand, for an unhealthy eye, the imaged glands show irregularities. Thus, it is important to detect each gland and extract features such as orientation, width, length, curvature, etc., for the purpose of automated dry eye diagnosis and risk assessment.

FIGS. 1(a)-(c) are three sample IR images of an ocular surface. FIG. 1(a) has been graded manually by an expert as “healthy”, FIG. 1(b) as “intermediate” and FIG. 1(c) as “unhealthy”. In this document such images are respectively referred to as “healthy images”, “intermediate images” and “unhealthy images”. The IR images have several features that make it challenging to automatically detect the gland regions:
1. low-contrast between gland and non-gland regions;
2. specular reflections caused from smooth and wet surfaces;
3. inhomogeneous gray-level distributions over regions because of thermal imaging;
4. irregularities in imaged regions of the ocular surface.

Even though there are diversities in imaging conditions, the gland regions have higher reflectance with respect to non-gland regions. Thus, the image regions belonging to a gland have relatively higher brightness with respect to neighbouring non-gland regions. However, because of the above mentioned imaging conditions, conventional methods such as local thresholding are not suitable for partitioning image into gland and non-gland regions.

### SUMMARY OF THE INVENTION

The present invention aims to provide automatic processing of images of an ocular region including a plurality of meibomian glands, such as to identify the locations of meibomian glands and/or to obtain numerical data characterising the glands. The numerical data may be used for grading the glands.

A first aspect of the invention proposes using an occular image of a region including meibomian glands to derive a grade indicative of the health of the meibomian glands, by using in the occular image to obtain one or more numerical parameters characterizing meibomian glands shown in the occular image; and automatically determining the grade using the one or more numerical parameters.

The grade may be used for a screening of patients, such as to identify patients who require more detailed examination. It can also be used to propose treatments to be performed on the patients.

The numerical parameters preferably include at least one of:
(i) at least one parameter characterizing the diversity between the scale parameters of significant features of the image obtained by a scale-space transform; and/or
(ii) at least one parameter obtained by measurement of lines identified in the occular image and representing respective glands. The measurement may be done of lines individually (e.g. the length of the lines) or relate to the pairs of neighbouring lines (e.g. distances between neighbouring lines).

A second aspect of the invention proposes in general terms that meibomian glands are identified on ocular images using Gabor filtering as a local filtering technique. The parametrization in shape, local spatial support, and orientation of Gabor filtering is particularly suitable for detecting meibomian glands.

### BRIEF DESCRIPTION OF THE FIGURES

Embodiments of the invention will now be described, for the sake of example only, with reference to the following figures in which:

FIG. 1, which is composed of FIGS. 1(a) to 1(c), shows three captured IR images of ocular surfaces;

FIG. 2, which is composed of FIGS. 2(a) to 2(f), shows representations of six Gabor functions;

FIG. 3, is composed of FIGS. 3(a) to 3(f), and includes FIG. 3(a) which is portion of FIG. 1(a), and FIGS. 3(b)-(f) which illustrate stages of processing the image of FIG. 3(a) using an embodiment of the invention;

FIG. 4, is composed of FIGS. 4(a) to 4(f), and includes FIG. 4(a) which is portion of FIG. 1(a), and FIGS. 4(b)-(f) which illustrate stages of processing the image of FIG. 4(a) using an embodiment of the invention;

FIG. 5, is composed of FIGS. 5(a) to 5(f), and includes FIG. 5(a) which is portion of FIG. 1(a), and FIGS. 5(b)-(f) which illustrate stages of processing the image of FIG. 5(a) using an embodiment of the invention;

FIG. 6, is composed of FIGS. 6(a) to 6(f), and includes FIG. 6(a) which is portion of FIG. 1(a), and FIGS. 6(b)-(f) which illustrate stages of processing the image of FIG. 6(a) using an embodiment of the invention;

FIG. 7, is composed of FIGS. 7(a) and 7(b) which respectively show an ocular image before and after histogram equalisation in a further embodiment of the invention;

FIG. 8 is composed of FIG. 8(a) which illustrates Scale Invariant Feature Transform (scale-space) points in a healthy image, and FIG. 8(b) which illustrates scale-space points in an unhealthy image;

FIG. 9 illustrates the distribution of scale invariance and Shannon entropy for a population of healthy and unhealthy images.

FIG. 10, illustrates the extraction of line features in the further embodiment of the invention;

FIG. 11 illustrates a process used by the further embodiment of the invention to extract contiguous lines from pixel clusters;

FIG. 12 shows the distribution of the total length of the lines extracted by the process of FIG. 11, and the number of lines, for healthy and unhealthy images;

FIG. 13 is a scatterplot of the lengths of lines, and the standard deviations in the lengths, for healthy and unhealthy images;

FIG. 14, which is composed of FIGS. 14(a) and 14(b), shows lines superimposed on ocular images, and including both lines representative of glands and spurious lines;

FIG. 15 shows the distribution of the maximum and minimum distances of the ends of the lines from the edge of the images;

FIG. 16 is a variant of FIG. 21 including also points for intermediate images;

FIG. 17 is a flow diagram of the first embodiment of the invention; and

FIG. 18 is a flow diagram of a further embodiment of the invention.

### DETAILED DESCRIPTION OF THE EMBODIMENTS

### 1st Embodiment

### 1.1 GABOR FUNCTIONS

The first embodiment of the invention is a method of detecting meibomian glands, making use of the family of two-dimensional (2D) Gabor functions. It is known to use a Gabor function as a receptive field function of a cell, to model the spatial summation properties of simple cells [1]. A modified parametrization of Gabor functions is used to take into account restrictions found in the experimental data [2, 3]. Suppose there is a light impulse at a point (x, y) on a 2-dimensional visual field Ω (that is (x, y)∈Ω⊃R²). The Gabor function is denoted by G_{λ,θ,ψ}(x, y) which is a real valued number (i.e. G_{λ,θ,ψ}(x, y)∈R). The Gabor function is given by [2]:

$${G}_{λ , θ , ψ} ( x , y ) = exp ( - \frac{{\tilde{x}}^{2} + {γ}^{2} {\tilde{y}}^{2}}{2 {σ}^{2}} ) cos ( 2 π \frac{\tilde{x}}{λ} + ψ ) - {G}_{λ , θ , ψ}^{DC} \qquad ( 1 )$$

where

\check{x}=(x−x₀)cos(θ−π//2)÷(y−y₀)sin(θ−π/2),

\tilde{y}=−(x−x₀)sin(θ−π/2)+(y−y₀)cos(θ−π/2),

and G_{λ,θ,ψ}^{DC} is DC term due to cosine function. The DC term

$${G}_{λ , θ , ψ}^{DC} = {\int \int }_{Ω} {G}_{λ , θ , ψ} ( x , y ) d x d y \qquad ( 1 )$$

is subtracted from G_{λ,θ,ψ} to remove the bias.

Without loss of generality, it is assumed in the embodiment that Gabor function is centered at the coordinate plane of the receptive field. Thus, x₀ and y₀ are not used to index a receptive field function. The parameters σ,γ,λ,θ and ψ are explained below.

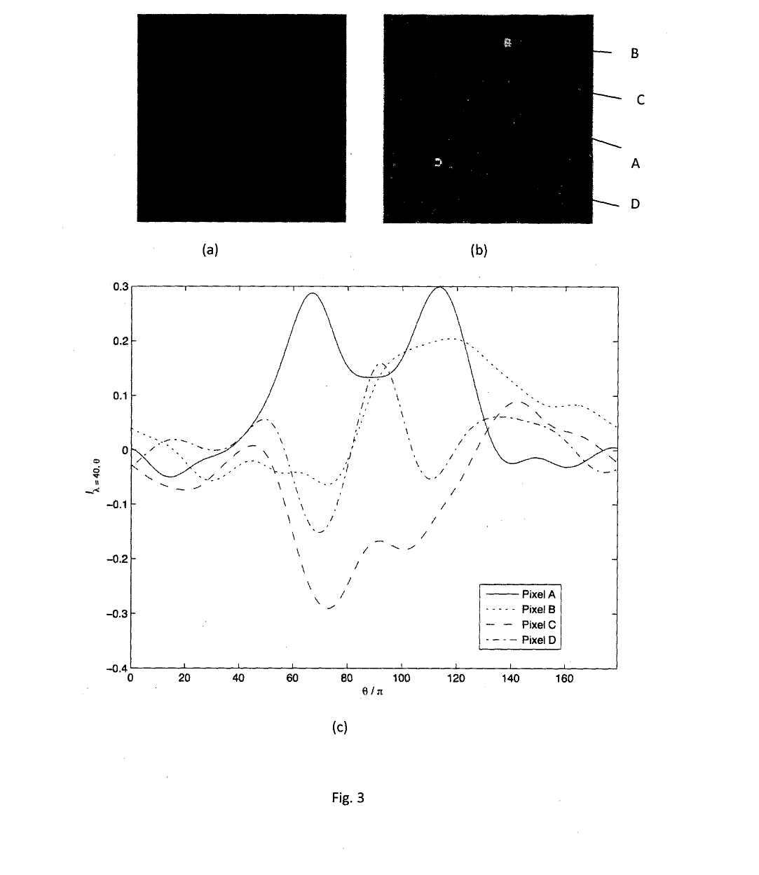

The size of the receptive field is determined by the standard deviation σ of the Gaussian factor. The parameter γ is in the range 0.23 to 0.92 (i.e. γ∈(0.23.0.92)) [2] and is called the spatial aspect ratio. It determines the ellipticity of the receptive field. The value γ=0.5 is used in the experimental results below, and, since this value is constant, the parameter γ is not used to index a receptive field function. The parameter λ is the wavelength and 1/λ is the spatial frequency of the cosine factor. The ratio σ/λ determines the spatial frequency bandwidth, and, therefore, the number of parallel excitatory and inhibitory stripe zones which can be observed in the receptive field as shown in FIG. 2 (as explained below). The half-response spatial frequency bandwidth b∈[0.5. 2.5] (in octaves) [2] of a linear filter with an impulse response according to Eqn. (1) is the following function of the ratio σ/λ [2]:

$$b = {log}_{2} ( \frac{\frac{σ}{λ} + \frac{1}{π} \sqrt{\frac{ln ( 2 )}{2}}}{\frac{σ}{λ} - \frac{1}{π} \sqrt{\frac{ln ( 2 )}{2}}} ) \qquad ( 3 )$$

or inversely

$$\frac{σ}{λ} = \frac{1}{π} \sqrt{\frac{ln ( 2 )}{2}} \frac{{2}^{b} + 1}{{2}^{b} - 1} . \qquad ( 4 )$$

The value b=1.0 is used in the embodiment and, since this value is constant, the parameter σ, which can be computed according to Eqn. (4) for a given λ, is not used to index a receptive field function. The angle parameter θ∈|[0,π) determines the preferred orientation from the x-axis in counterclockwise direction. The parameter ψ∈(−π, π] is a phase offset that determines the symmetry of G_{λ,θ,ψ}(x, y) with respect to the origin: for ψ=0 and ψ=π it is symmetric (or even), and for ψ=π/2 and ψ=π/2 it is antisymmetric (or odd); all other cases are asymmetric mixtures.

FIG. 2 is an intensity map of Gabor functions with parameters θ=π/4, ψ=0.0 and (a) λ=10 pixels; (b) λ=20 pixels; (c) λ=30 pixels; (d) λ=40 pixels; (e) λ=50 pixels and (f) λ=60 pixels on 256×256 pixels grid, which model the receptive field profile of a simple cell. Gray levels which are lighter and darker than the background indicate zones in which the function takes positive and negative values, respectively. The bright ellipse \tilde{x}²+(γ\tilde{y})=4σ² specifies the boundary of the (classical) receptive field outside which the function takes negligibly small values.

Using the above parametrization for Gabor function, one can compute the response I_{λ,θ,ψ} to an input 2D image I as

I_{λ,θ,ψ}=I*G_{λ,θ,ψ,} (5)

where * denotes 2D convolution. Eqn. (5) can be efficiently computed using the Fourier transform (F), i.e., I_{λ,θ,ψ}=F⁻¹(F(I)F(G_{λ,θ,ψ})) where F⁻¹ is the inverse Fourier transform.

### 1.2 EXTRACTING FEATURES USING GABOR FILTERING

Realizations of Gabor functions shown in FIG. 2 can be used to model the local structure of a gland which is surrounded by non-gland regions. That is, the main lobe in the middle represents the gland, and the side lobes on both sides of main lobe represent non-gland regions. The parameter λ can be used as an estimate for the spatial width, and the parameter θ can be used as an estimate to local orientation of sub-gland structure. The value ψ=0.0 is used. Without loss of generality, the parameter ψ is not used as index unless otherwise stated.

The parameter λ takes discrete integer values from a finite set {λᵢ} and can be estimated according to expected spatial width of the consecutive gland and non-gland regions. Meanwhile, it is expected that sub-gland structure can have any orientation in between [0, π). However, it impossible to test every possible orientation. Thus, the parameter θ is discretized according to:

$${θ}_{i} = \frac{( i - 1 ) π}{{N}_{θ}} , \\ i = 1 , 2 , … , \text{?} \\ \text{?} \text{indicates text missing or illegible when filed} \qquad ( 6 )$$

where N_{θ} is the total number of discrete orientations.

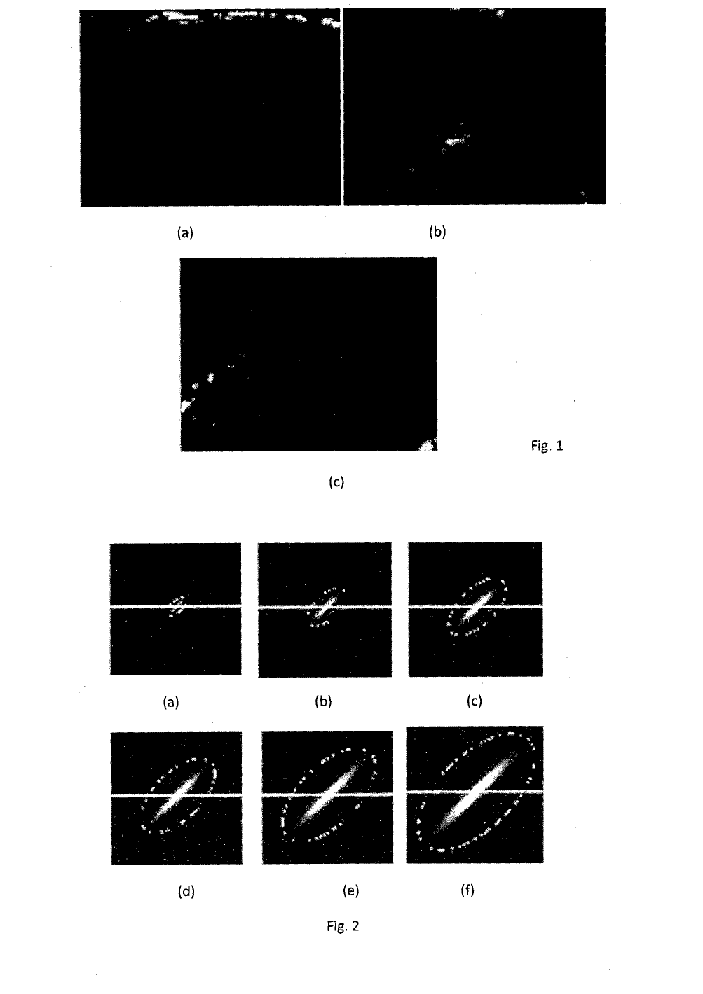

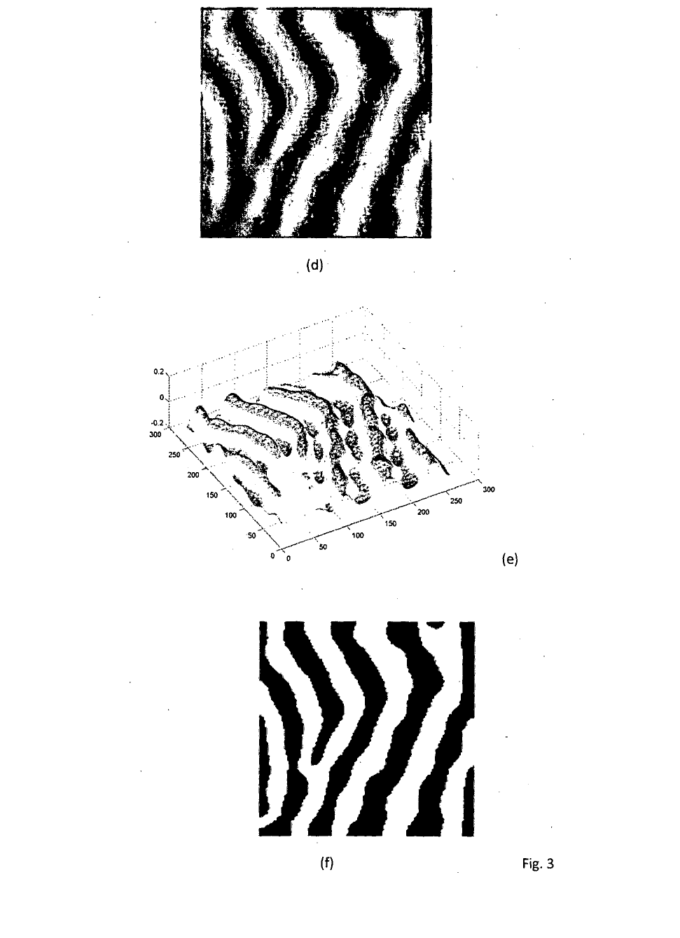

For a rough estimate of correct λ and θ for each pixel, the Gabor filter response is positive over gland region, but it is negative over non-gland regions. In order to demonstrate this, a sub-region of IR image from FIG. 1(a) is used, and shown in FIG. 3(a). Below we will explain the steps of using FIG. 3(a), and values λ=40 pixels and N_{θ}=180 to derive a binarized filter response shown in FIG. 3(f). FIG. 3(b) is a contrast enhanced IR image in which the boundary pixels of the regions of FIG. 3(f) are overlayed, and four pixel locations are labelled as A, B, C, D. Pixels A and B are on gland regions, and pixel C is on a non-gland region. Pixel D is is on the border of a gland region and a non-gland region.

FIG. 3(c) shows the Gabor filter responses of the four pixels shown in FIG. 3(b). The Gabor filter responses for different pixel locations falling into regions of gland and non-gland areas are reported in FIG. 3(c) plotted against the variable θ. The maxima of absolute valued Gabor filter responses of pixels A and B are realized when the sign of Gabor filter response is +1, meanwhile, the sign of the maximum value of absolute valued Gabor filter response is −1 for pixel C. Thus, for a pixel over gland region which is surrounded by non-gland regions, there is a high difference between magnitudes of positive maximum and negative minimum. Similarly, for a pixel over a non-gland region which is surrounded by gland regions, there is a high difference between magnitudes of negative minimum and positive maximum. However, when the pixel resides on a region which has very close proximity between gland and non-gland regions, e.g., pixel D on FIG. 3(b), the difference between magnitudes of positive maximum and negative minimum is small, as shown in FIG. 3(c). It is also clear that the sign of average Gabor response is +1 over gland regions, and is −1 over non-gland regions.

For a given λ, the mean Gabor response Î_{λ} is computed as follows:

$$\begin{matrix}{\hat{I}}_{λ} = \frac{{\int }_{0}^{π} {I}_{λ , θ} d θ}{{\int }_{0}^{π} d θ} \\ = \frac{1}{θ} {\int }_{0}^{π} {I}_{λ , θ} d θ ,\end{matrix} \qquad ( 7 )$$

which is approximated as

$${\hat{I}}_{λ} = \frac{1}{{N}_{θ}} {\sum }_{i = 1}^{{N}_{θ}} {I}_{λ , {θ}_{i}} . \qquad ( 8 )$$

In FIG. 3(d) the average Gabor filter response Î_{λ=40} of the input image FIG. 3(a) computed according to Eqn. (8) is shown for λ=40 pixels and N_{θ}=180. The corresponding surface plot is given in FIG. 3(e). It is clear from FIGS. 3(d) and 3(e) that the filter gives high positive responses on gland regions, while it produces low negative responses on non-gland regions. Thus using this observation, one can easily segment out gland regions from non-gland regions using the sign of filter response, i.e.,

\hat{B}_{λ}(x, y)=H(Î_{λ}(x, y)) (9)

where H(α)∈{0, 1} is a binary function defined as

$$H ( a ) = \{ \begin{matrix}1 , & if α \geq 0 ; \\ 0 , & otherwise .\end{matrix} \qquad ( 10 )$$

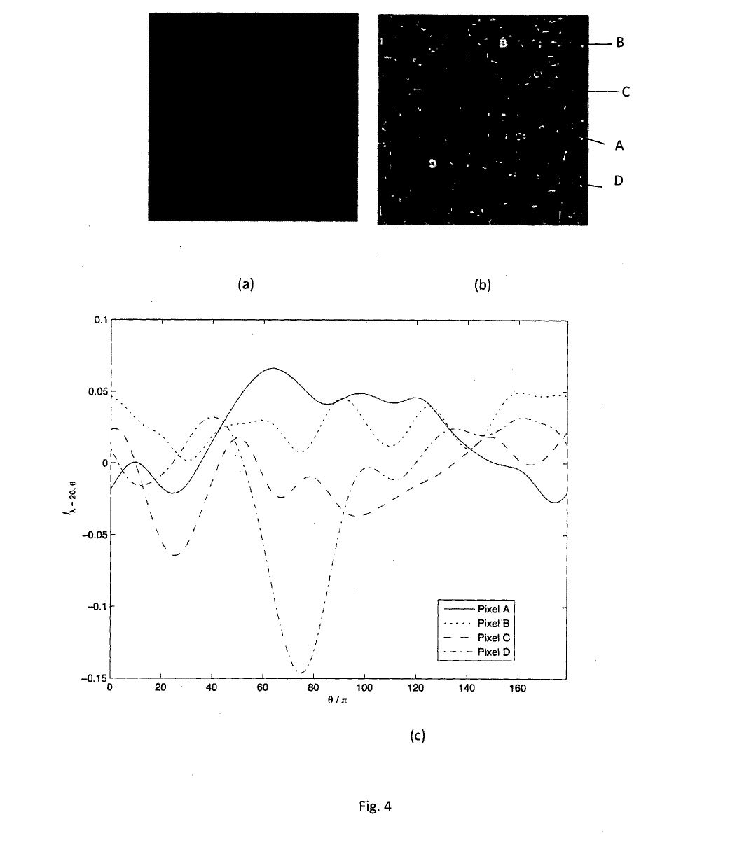

In FIG. 3(f) the binarized Gabor filter response \hat{B}_{λ} according to Eqn. (9) is shown. Overall, the segmentation result looks satisfactory. However, it can be observed that at pixel D two glands regions are merged together where the separation between two glands is distinct in the surface plot shown in FIG. 3(e). This can be due to two reasons: 1) the value of λ is too large to resolve the signal separation; and/or 2) the pixel D falls into an uncertain region where there is not enough information to separate two regions or the region belongs to some other parts of the ocular surface. In latter case, further analysis is required. However, the former case can be resolved by analysing the image at different values of λ. For example in FIG. 4, the same input image shown in FIG. 3(a) is analysed using λ=20 pixels and N_{θ}=180. FIG. 4(a) is is the same as FIG. 3(a), and each other part of FIG. 4 corresponds to a respective image in FIG. 3. It is clear that the pixel D is segmented correctly at the expense of incorrect segmentations in other regions.

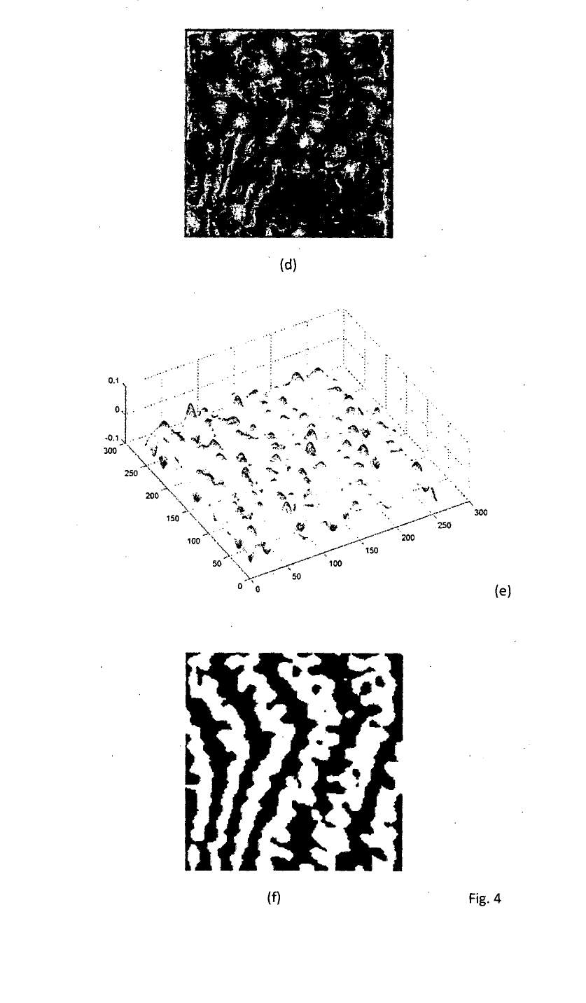

Corresponding results for λ=30 pixels and N_{θ}=180 are shown in FIG. 5, in which each image corresponds to the respective image in FIG. 3.

The results obtained by exploiting different values of λ show various trade-offs yielded between spatial-detail preservation and noise reduction. In particular, images with a lower value of λ are more subject to noise interference, while preserving more details of image content. On the contrary, images with a higher value of λ are less susceptible to noise interference, but sacrificing more degradations on image details.

The average Gabor filter responses for each distinct value of λ∈{λᵢ} is used in vector representation f_{x,y} for each pixel (x, y) of input image as

$$\begin{matrix}{f}_{x , y} = [ {f}_{x , y} ( 1 ) , … , {f}_{x , y} ( i ) , … , {f}_{x , y} ( {N}_{λ} ) ] ; \\ = \frac{[ {I}_{{λ}_{1}} ( x , y ) , … , {I}_{{λ}_{i}} ( x , y ) , … , {I}_{{λ}_{{N}_{λ}}} ( x , y ) ]}{\sqrt{{\sum }_{i = 1}^{N} {I}_{{λ}_{i}}^{2} ( x , y )}}\end{matrix} \qquad ( 11 )$$

where N_{λ} is the cardinality of the set {λᵢ} is a positive integer (i.e. i∈Z⁺), and

$${f}_{x , y} ( i ) = \frac{{I}_{{λ}_{i}} ( x , y )}{\sqrt{{\sum }_{k = 1}^{{N}_{λ}} {I}_{{λ}_{k}}^{2} ( x , y )}} . \qquad ( 12 )$$

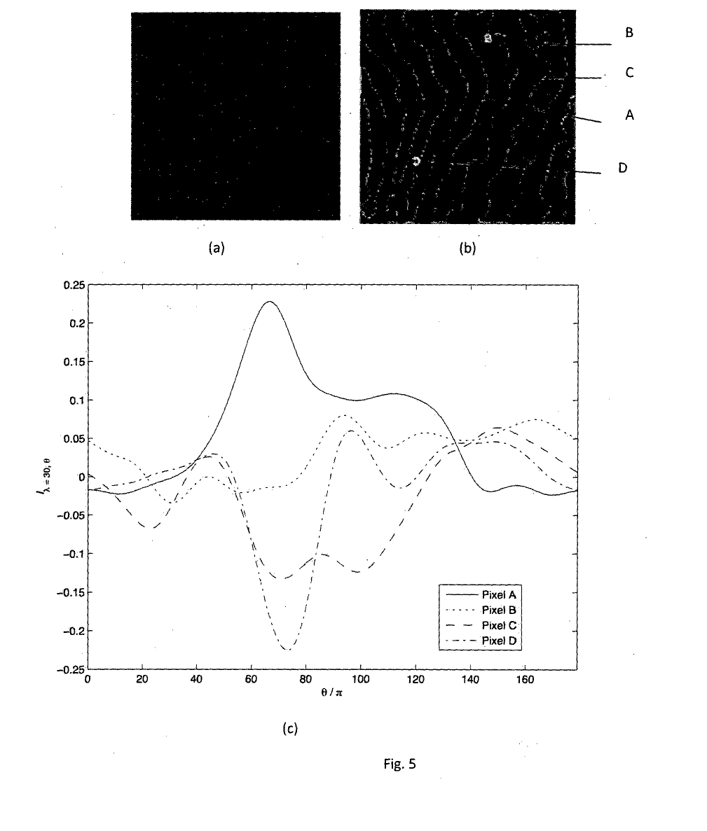

The denominator in Eqn. (12) is used to compensate the fluctuations due to illumination differences over different parts of the image. In FIG. 6, Gabor filter responses according to Eqn. (12) are shown for N_{λ}=16 and N_{θ}=180. FIG. 6(a) is the same as FIGS. 3(a), 4(a) and 5(a). Below we will explain the steps of using FIG. 6(a) to derive a binarized filter response shown in FIG. 6(f). FIG. 6(b) is a contrast enhanced IR image in which the boundary pixels of the regions of FIG. 6(f) are overlayed, and the four pixel locations are labelled as A, B, C, D are as in FIGS. 3 to 5. FIG. 6(c) shows the Gabor filter responses of the four pixels shown in FIG. 6(b) according to Eqn (12). The Gabor filter responses for different pixel locations falling into regions of gland and non-gland areas are plotted in FIG. 6(c). From the feature vectors shown in FIG. 6(c), the feature vectors are positive on gland regions, and negative in non-gland regions. However, they fluctuate between negative and positive values for pixel D. The average feature \hat{F} is computed as

$$\hat{F} ( x , y ) = \frac{1}{{N}_{λ}} {\sum }_{i = 1}^{{N}_{λ}} {f}_{x , y} ( i ) . \qquad ( 13 )$$

which is depicted in FIG. 6(d) and (e) where the discrimination between gland and non-gland regions are clear. Using Eqn. (13), the final binary image is computed according to

\hat{B}(x, y)=H(\hat{F}(x, y)). (14)

where H(·) is defined in Eqn. (10). The result of binarization according Eqn. (14) is shown in FIG. 6(f) and the boundaries are overlayed onto input image in FIG. 6(b). It is clear that merging information from different values of λ improves the discrimination between gland and non-gland regions.

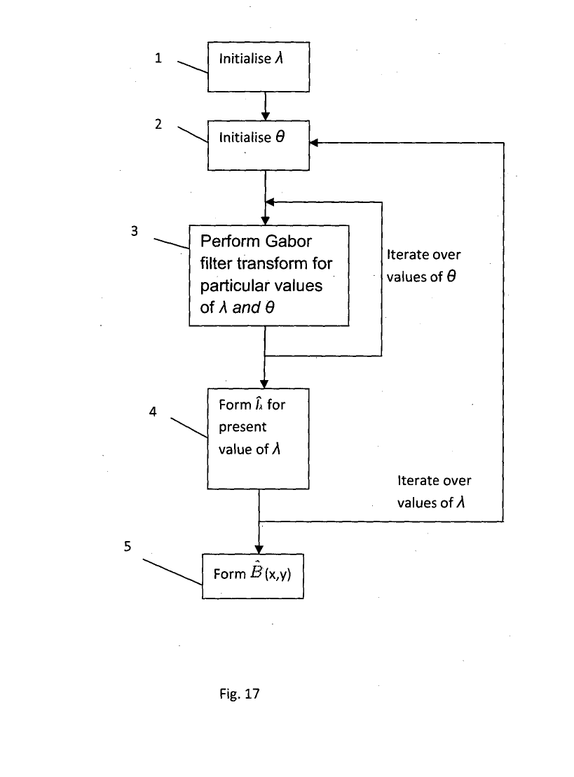

Thus, the steps of the first embodiment are as shown in FIG. 17. In step 1 the value of λ is initialised (i.e. i is set to first value, so as to set λᵢ). In step 2, θ is initialised. In step 3, the values of λ and θ are used to perform a Gabor filter transform. This step is repeated for each of the possible values of θ, and the result is used in step 4 to form the value of I_{λ}0 for this value of λ. The result is iterated over the possible values of λ, and the result is used to form \hat{B} in step 5 using Eqns. (13) and (14).

### 2nd Embodiment

The second embodiment aims to provide a way of grading a subject, i.e. alloting him into one of at least two categories, such as “healthy”, “unhealthy” or “intermediate”.

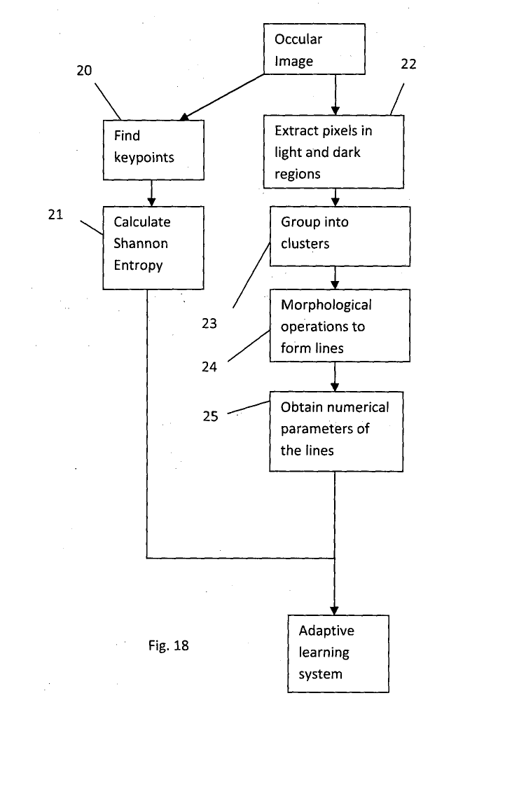

The overall method of the second embodiment is illustrated in FIG. 18. A single occular image is used to obtain one or more numerical parameters (“features”) indicative of whether the image is healthy or not. Note that not all the numerical parameters described below may be collected in realisations of the embodiment, but preferably more than one parameter is collected, and in this case the numerical parameters are combined by an adaptive learning system (such as a support vector machine (SVM) which has been subject to supervised learning), to generate an output indicative of whether the image is healthy or not.

### 2.1 ENHANCING CONTRAST USING HISTOGRAM EQUALIZATION

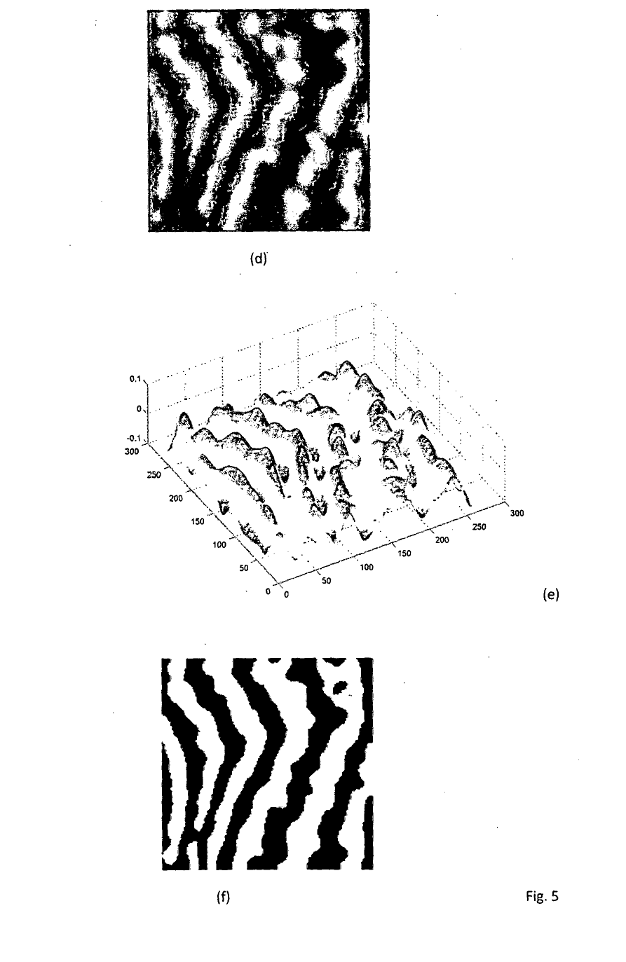

The original images have poor contrast. To improve contrast, we applied a standard technique called Histogram Equalization. The original image is shown in FIG. 7(a) and the image with improved contrast is shown in FIG. 7(b) for comparison. The operations in the second embodiment are performed on the images after Histogram Equalization.

### 2.2 SCALE-SPACE-SHANNON ENTROPY FEATURE

### 2.2.1 SCALE-SPACE TRANSFORM

The second embodiment employs a feature called the Scale-Space-Shannon Entropy feature to distinguish a healthy from an unhealthy image. This concept is adapted from a well-known method called Scale Invariant Feature Transform (SIFT) described in [4]. In short, in step 20 of FIG. 19, the embodiment locates keypoints on an image, called scale-space points. Each scale-space point is represented by a vector with 3 elements (x,y,s) (note that by contrast the SIFT transform uses a further 129 elements which are not employed in the embodiment). x and y are the Cartesian coordinates of the scale-space point on the image, s is called its scale The scale-space points are found by the following “scale-space transform”:
convolving the (x,y) ocular image with Gaussian filters at different distance scales s;
seeking maxima (x,y,s) of the difference between subsequent pairs of the images with different s to form candidate keypoints; and
rejecting candidate keypoints which for which the contrast with next-neighbour points is below a threshold.

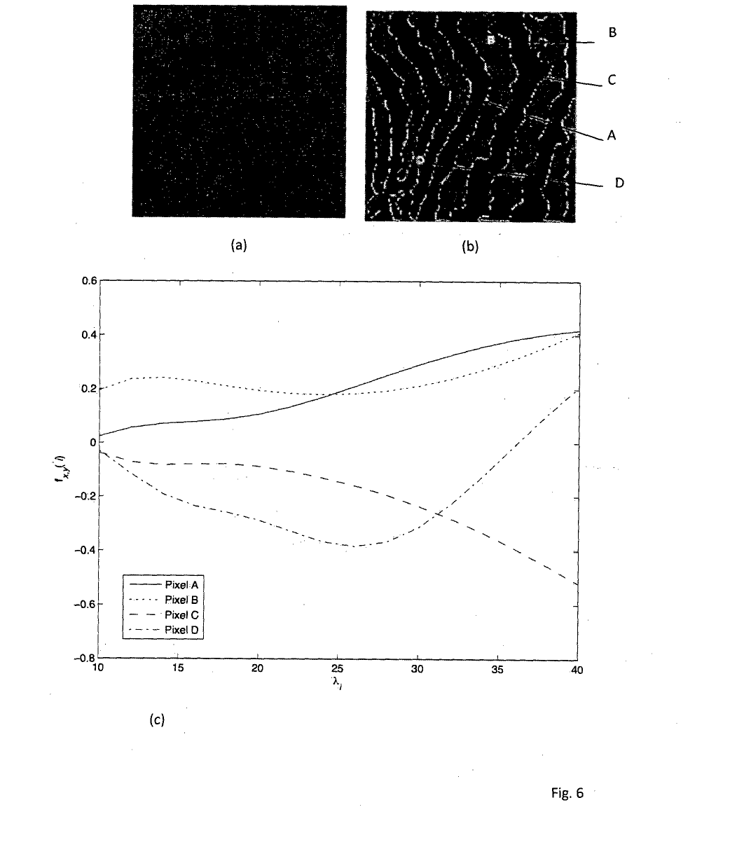

FIG. 8 shows how the scale-space points look on two images: a healthy image (FIG. 8(a)) and an unhealthy image (FIG. 8(b)). Each scale-space point is represented as a circle, and the horizontal bar of the circle (i.e. the radius) indicates its scale s.

The embodiment employs the observation that, as shown in FIG. 8, within a local region (shown by the boxes), the circles of healthy images are of similar sizes, whereas the circles of unhealthy images are of very different sizes. This is because in healthy images, there are evenly-spaced strips of similar thickness (i.e. the glands), and the scale-space transform picks up this pattern. Unhealthy images, on the other hand, do not have this pattern (i.e. no glands), and the sizes of the circles are therefore of very different magnitudes.

In step 21 of FIG. 18, the embodiment generates a numerical measure of the disparity of the sizes of the circles, and the embodiment makes use of the fact that the local distribution of scales is uniform for a healthy image and non-uniform for an unhealthy one to distinguish between the two classes. One mathematical function which can measure this uniformity is the well-known Shannon Entropy, which we will now discuss.

### 2.2.2 SHANNON ENTROPY

Shannon entropy is defined as

$$S = - {\sum }_{i = 1}^{n} {p}_{i} ln {p}_{i} , \qquad ( 15 )$$

where pᵢ is the probability of event i. The pᵢ's must be normalized, i.e. Σᵢ₌₁ⁿpᵢ=1.

One important property of the Shannon Entropy that we use is that it is maximized if and only if pᵢ is a uniform distribution, i.e. pᵢ=√n. For the proof, refer to [5].

The scale of the SIFT points can be related to the probability distribution in the following way. First, choose a scale-space point and consider its n nearest neighboring scale-space points. We define the ‘probability’ of the i-th nearest neighbor with respect to this ‘central’ scale-space point as

$${p}_{i} = \frac{{( {s}_{i} )}^{2}}{{\sum }_{i = 1}^{n} {( {s}_{i} )}^{2}} \qquad ( 16 )$$

where i=1, . . . , n labels the n nearest-neighbouring scale-space points and sᵢ is the scale of the i-th scale-space point.

The denominator in Eqn. (16) ensures that 0<pᵢ<1, and that the distribution is normalized. The meaning of pᵢ is the ratio of the area of the circle of the ith neighbor to the total area of all the neighbors.

Referring back to FIG. 8, we see that for the box in FIG. 8(a), all the circles are roughly the same size, so pᵢ will also be roughly the same, and hence the entropy computed within that blue box should be close to maximal. For FIG. 8(b), on the other hand, because the circles are very non-uniform, pᵢ computed according to Eq. (16) is also very non-uniform, and so the entropy computed within that blue box will be low compared to (a).

### 2.2.3 ALGORITHM TO COMPUTE SHANNON ENTROPY OF AN IMAGE

To compare the entropies of two different images, we need to compute the Shannon Entropy for an entire image. The algorithm to do this is as follows.
1. Obtain all the scale-space points for an image (using standard techniques). Say the total number of scale-space points is M. Denote a scale-space point as α, where α=1, . . . , M.
2. For an α, identify its n nearest neighbors (usually n=20). (In cases in which the n nearest neighbours are not unambiguously defined (e.g. because there are 3 scale-space points exactly the same distance away and 19 scale-space points closer; or to put this more generally, if for the smallest distance d such that there are at least n points no further than d from α, the number of scale-space points no further than d from α is m which is greater than n), the algorithm can randomly take n of these m points, or alternatively use all m of these points)
3. If {s₁^{α}, . . . , sₙ^{α}} are the scales of these n nearest neighbours, let s^{α}=Σᵢ₌₁ⁿ(sᵢ^{α})², and let pᵢ^{α}=(sᵢ^{α})²/s^{α}.

4. Compute the entropy for α: S^{α}=−Σᵢ₌₁ⁿpᵢ^{α} In pᵢ^{α}
5. Repeat Steps 1 to 3 for all scale-space points, i.e. α=1, . . . , M.
6. The Shannon Entropy for the entire image is the average

$$\text{?} = \frac{1}{M} \text{?} \\ \text{?} \text{indicates text missing or illegible when filed} \qquad ( 17 )$$

### 2.2.4 RESULTS

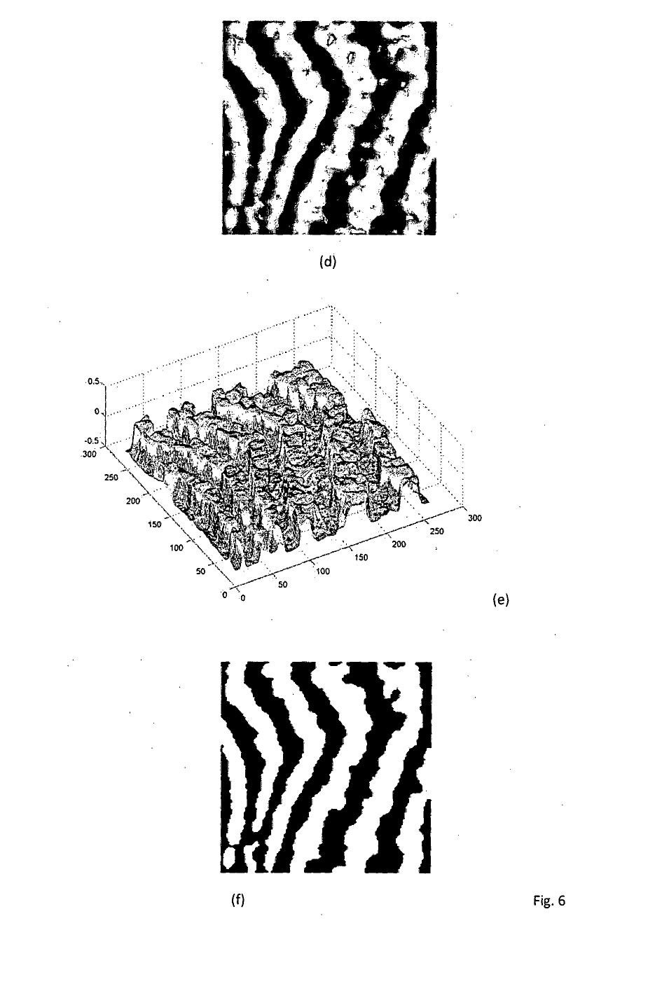

To see whether the scale-space-Shannon Entropy feature can distinguish between healthy and unhealthy meibography images, we manually graded some healthy and unhealthy images, and computed their entropy S. The results are shown in FIG. 9.

Each image is represented as a point. The horizontal axis represents entropy S. The vertical axis isr included only for ease of visualisation. Healthy images are plotted as lighter dots, and unhealthy images as respective darker dots. The result shows that the healthy cluster is quite well separated from the unhealthy cluster along the Shannon Entropy dimension.

### 2.3 LINE FEATURES

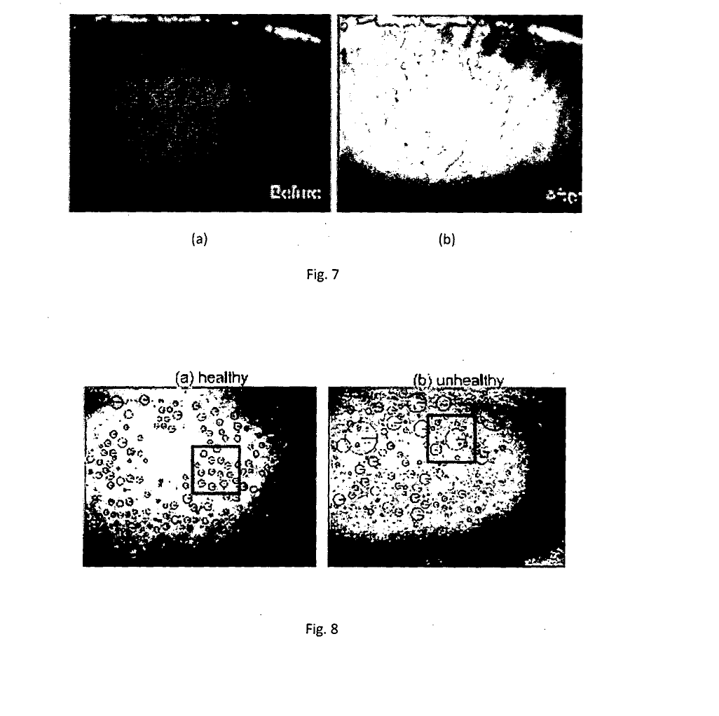

The embodiment uses a further method to extract other features, which we call Line Features, from the images. As explained, the most salient characteristic of a healthy image are the vertical gland patterns, shown in the top left panel of FIG. 10. The embodiment obtains clusters of pixels indicative of these glands, as shown in the two bottom panels of FIG. 10. The procedure can be summarized as follows.
1. Extracting pixels that lie along the bright and dark line regions (i.e. gland patterns). This is step 22 of FIG. 18.
2. Grouping the pixels into ‘primitive’ clusters that resemble line patterns. This is step 23 of FIG. 18.
3. Morphological operations on each cluster to form a line from the cluster. This is step 24 of FIG. 18.
4. Obtaining numerical properties of the lines (e.g. their length and/or curvature) as features for classification. This is step 25 of FIG. 18.

In the following, we shall describe each of the above steps.

### 2.3.1 EXTRACTING LOCAL MINIMA AND MAXIMA PIXELS

To extract the local minima, we first smooth the entire image (implemented using the cvSmooth algorithm from the well-known OpenCV library of programming functions) so that the values of the intensity change smoothly from one pixel to another. Then, using the intensity as a kind of ‘potential energy surface’, we can seek minima of the surface.

One way to do this is to perform gradient descent to reach the minima of the surface. Specifically, the procedure is as follows.
1. Consider a horizontal cross section of the image, i.e. one row. Denote the intensity at the ith pixel as I[i].
2. Consider a ‘particle’ located at the ith pixel.
3. Compute the ‘force’ on it as

f[i]=−(I[i+1]−I*[i−1]) (18)
(which is just a simplified version of the gradient formula −∂V/θx.) If f[i]>0, move the particle to i+1; if f[i]<0, move it to i−1; if f[i]=0, then it stays at i. Note that since intensities are generally quoted in integer values (e.g. integers in the range 0 to 255) one would expect f[i]=0 at minima.
4. Repeat Step 3, until the particle stops moving, i.e. f=0. Denote the location of the particle as i*.
5. Repeat Steps 2 and 3, starting the particle from every pixel along the row, obtaining an i* for each starting pixel i. The set of all i*'s are the minima for the row.
6. Proceed to the next row and repeat Steps 2 to 5.

To obtain the maxima, one simply repeats the above but using −I instead of I for the pixel intensity.

An alternative algorithm is to scan along the row, and make a list of those points/pixels i that satisfy the following conditions: for maxima: I[i−1]<I[i]>I[i+1]; for minima: I[i−1]>I[i]<I[i+1]″.

### 2.3.2 CLUSTERING THE PIXELS

After obtaining all the minima and maxima points, we need to cluster them so that, to a first approximation, each cluster has a line-like shape. This will facilitate the next stage of converting the cluster into a contiguous line. To do our clustering, we use a well-known algorithm called First In First Out (FIFO). For specificity, we use the threshold of 10 pixels, which means that only pixels within less than 10 pixels of some other pixels in a cluster are grouped together. After this procedure, the minima (maxima) are grouped as shown in the bottom two panels of FIG. 10. Each of these cluster are then transformed into a contiguous curve using the method described in the next section.

### 2.3.3 TRANSFORMING A CLUSTER INTO A CONTIGUOUS CURVE

At this stage, each cluster resembles a line, but it is still not useful because it may be broken, and it is not one pixel thick. Here, we present an algorithm, based on well-known methods, to transform a cluster into a curve. While each of the methods used by the embodiment is known as unrelated method, the embodiment combine these methods to achieve the purpose of converting a cluster of pixels into a contiguous curve.

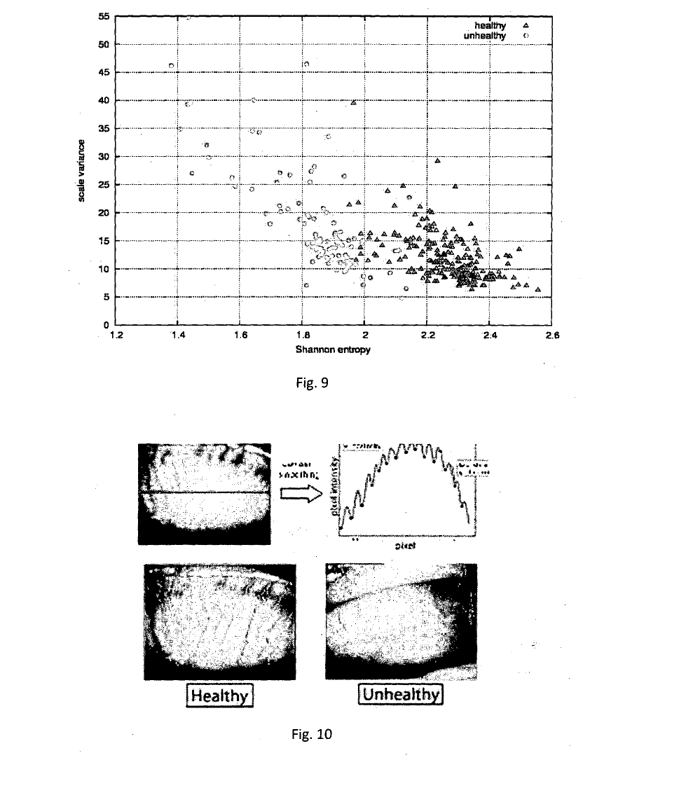

The sub-steps of step 24 in FIG. 18 are illustrated in FIG. 11, and are described below.
1. Choose one cluster and put it into an image. Specifically, we set all the pixels belonging to that cluster as foreground (black in FIG. 11), and all other pixels as background (i.e. white). This is shown in the first panel of FIG. 11.
2. Next, we apply cvDilate (which is another algorithm available in OpenCV) to thicken the cluster by one pixel. The purpose is to merge all the pixels into one connected piece. After one application of cvDilate, we check to see if the cluster now consists of a single connected component. If yes, we proceed to the next step, otherwise, we apply cvDilate again until one single connected component is obtained.
3. The previous step may produce a connected component containing ‘islands’ of background, highlighted by the circle in the second panel of FIG. 11. These islands must be eliminated because they will give rise to ‘loops’ in the contiguous line in the later steps. To eliminate all them, we use cvFloodFill (which is another algorithm available in OpenCV) to fill out the background first, revealing the locations of these islands as the remaining white pixels. We then go back to the pre-cvFloodFill image and set these islands to foreground (i.e. black). This produces a connected component which does not contain these problematic islands.
4. We then use a standard thinning algorithm [6] to thin the component until one pixel thick.
5. The connected component is now a ‘tree’ with many branches. The embodiment prunes away all the side branches. To do this, we first locate and count the number of terminal points (i.e. end points) on the tree. We then use a standard pruning algorithm [7] to prune away all side branches with pruning factor 1, i.e. branches which are 1 pixel long are eliminated. We then count the number of end points again, and if it is not 2, we increase the pruning factor by 1 and prune again. The procedure is repeated until only two end points are left, meaning that the tree has no more branches left.
6. This completes the procedure for transforming a cluster into a contiguous line. We then go repeat Steps 1 to 5 for another cluster.

### 2.3.4 SELECTING FEATURES, AND CLASSIFICATION OF HEALTHY AND UNHEALTHY IMAGES

We now present features (i.e. numerical parameters) derived in step 25 of FIG. 18 from the lines obtained to help us distinguish between the healthy and unhealthy images. The features are:
1. Number of lines.
2. Total length of lines.

The following all alternative features which may be used.
3. Potential energy.
4. Left-Right distance.
5. Twistedness.

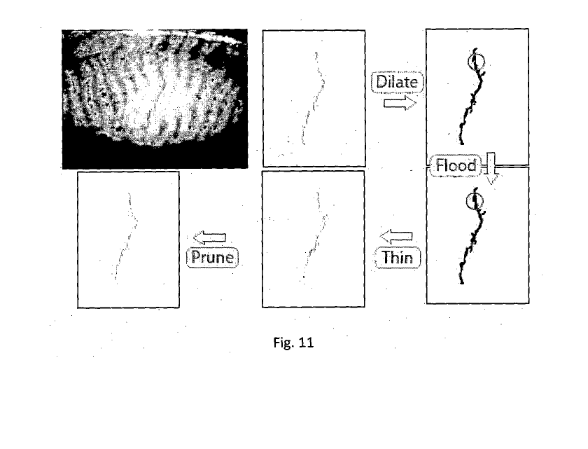

No. of Lines vs Total Length As the first two features, we choose the ‘number of lines’ and ‘total length of the lines’. The idea is explained graphically in FIG. 12. For a healthy image, there are fewer lines, and all the lines are long; for an unhealthy image, there are more lines, and the lines are short. If we plot these two features, the healthy and unhealthy images can be separated, as shown in the bottom panels of FIG. 12.

Potential Energy The next feature is called ‘potential energy’. We first find the nearest neighbor of a minimum (maximum) point. We then compute its potential energy. The potential energy is zero everywhere except at the distance of around 50 pixels (=spacing between strips) where it becomes negative. Hence, for healthy images, we expect the total potential energy of an image to be negative, whereas for unhealthy images we expect it to be close to zero.

Left-Right Distance The next feature is called Left-Right Distance. We start off from a point, and move in the two directions perpendicular to the tangent at that point. For each direction, we compute the distance where the embodiment first encounters another point (d₁ and d₂ in the figure). The distribution of points on the d₁-d₂ plane can be used to construct a histogram. The first two components of the histogram are good features to separate healthy and unhealthy images.

Twistedness Our last feature is called Twistedness, and it is based on the observation that the lines for healthy images are less twisted than those for unhealthy images. To quantify twistedness, we define it as the ratio of the distance between the ends of the line (“straight length”) and the length of the line (“arc length”). For each image, a histogram can be computed for the distribution of twistedness of its lines. We then further coarse grain the histogram into two bins, and use these as the feature space.

### 2.4 VARIATIONS IN THE SECOND EMBODIMENT

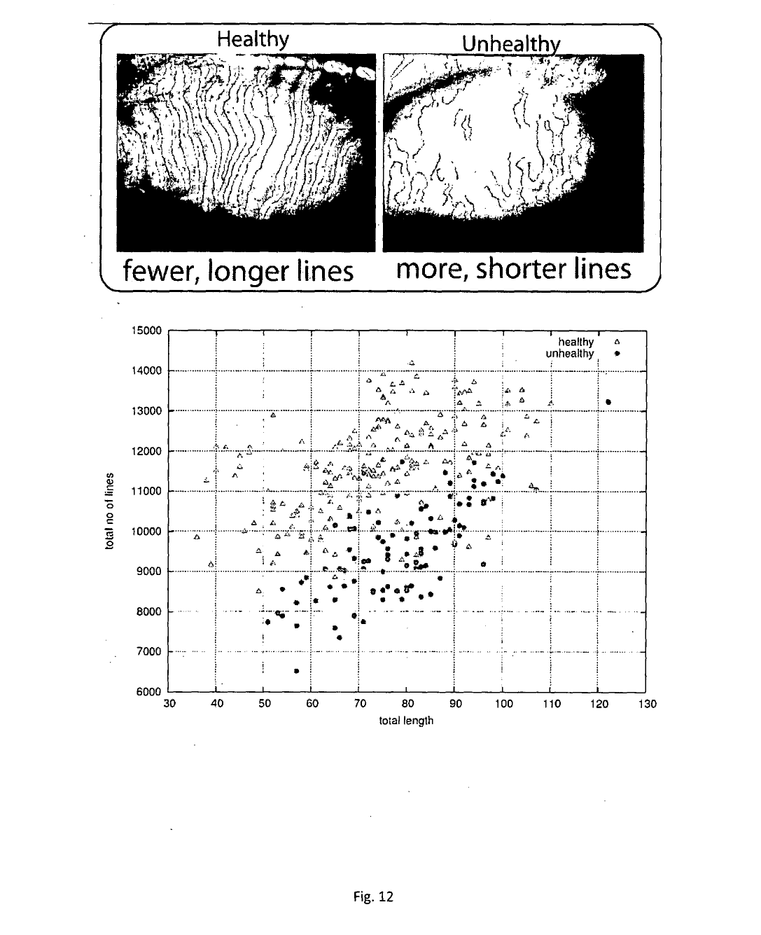

The features discussed above are not the only features which can be derived in step 25 from the lines obtained in step 24. Two further possible features are the average of the length of all the lines in an image, and the standard deviation of length of the lines. FIG. 13 shows the scatter plot of the images based on these two features. Each point represents an image. The circle-shaped and diamond-shaped points represent the healthy and unhealthy images respectively. It is clear that using standard techniques like Support Vector Machines, the two classes of images can be classified. This method has been reported in our recent publication in Journal of Biomedical Optics 17(8) 0860008, (2012).

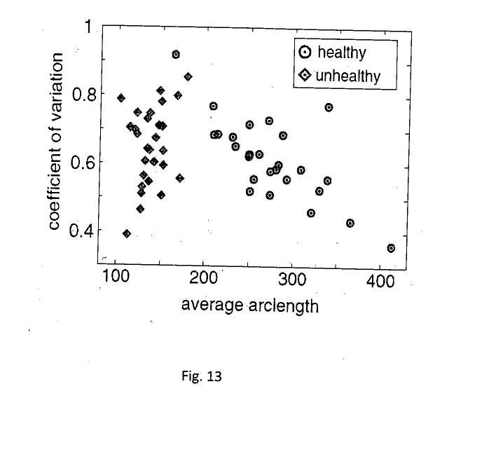

Furthermore, many variations are possible in the technique used to obtain the lines, and improvements can be made. Although the algorithm presented above for extracting line features from the image is effective for classification of the extreme cases of healthy and unhealthy images, it may be less effective to assess the intermediate stages, and it is valuable to minimise noise. Noise here means spurious lines that are extracted by the algorithm of FIG. 18 but are not due to meibomian glands. The majority of these lines are due to eye lashes or dark shadows at the periphery of the images. These are removed in order to remove noise from the subsequent statistics that we will compute from the lines. An example is shown in FIG. 14(a). Lines extracted by the method of FIG. 18 are marked. Lines marked X are due to the meibomian glands, but the lines marked Y near the edge are spurious and due to inhomogeneity in the pixel intensity, and are preferably excluded before step 25 is performed, i.e. excluded from subsequent calculation of statistics based on the lines. In the following, we describe an algorithm for automatically detecting the spurious lines Y.

The spurious lines Y have two important properties. They are much shorter than the majority of the lines, and they are close to the edges. However, it would not be appropriate to exclude all lines which are short because they are characteristic of unhealthy and intermediate images, as shown in FIG. 14(b). We see that due to the breaking up of the gland patterns in the center, there are many short broken lines in the center of the image. These must be be retained.

There are two stages to remove the spurious lines. In the first stage, we process each individual line in the following way.

(1) Label the top, bottom, left, and right edges of the images (as, for instance, 1,2,3,4 respectively). For every pixel of a line, check which side the pixel is closest to, and determine the distance of the pixel to this closest side. Call this number d.

(2) For each line, get the pixel with the smallest and largest d. Call them d_min and d_max respectively.

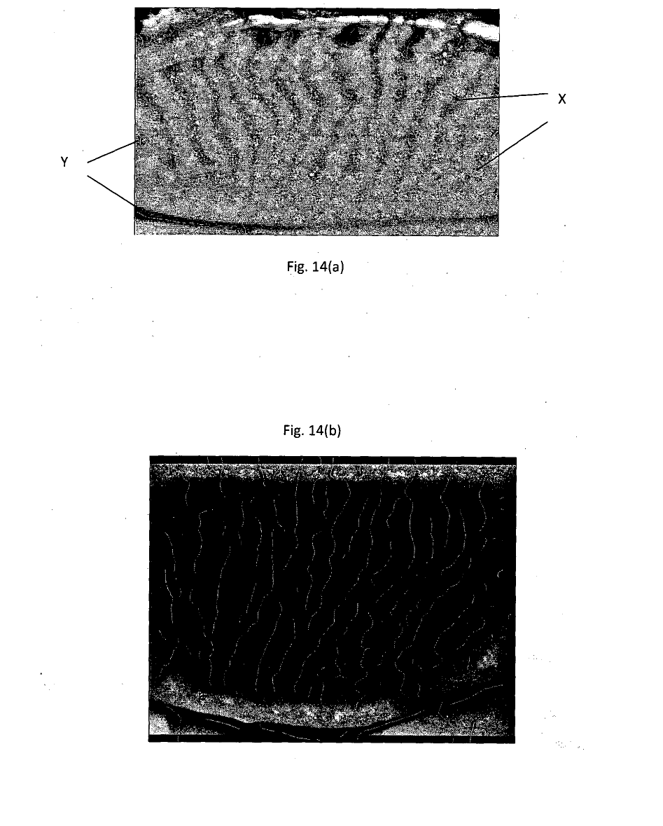

(3) Compute the d_min and d_max for all the lines on the images. Plot each line as a point in a two dimensional space where the x-axis is d_max-d_min, and the y-axis is d_max. The resulting scatter plot is shown in FIG. 15.

All the lines fall into one of three sectors in the 2-D plot. The lines which correspond to gland lines will lie in the top-right hand region. This is because they usually contain a pixel which is close to an edge, and hence a small d_min, but also contain a pixel which is near the center, and hence a large d_max. As a result, lines associated with glands will have large d_max-d_min and d_max.

A second category of lines belong to those which fall in the top left hand region. These are remnants of broken-up gland lines. They are short and lie near the center. As they lie near the center of an image, their d_max is large. But because they are short and near the center, the pixel with d_min is usually also in the proximity to the pixel with d_max, and d_min is approximately equal to d_max, giving a small d_max-d_min. This explains why they lie in the top left hand corner. These lines should also be included when step 25 is performed.

The spurious lines Y are those that lie close to the origin of the scatter plot. They are short and hence every pixel along the line will be close to the edge, hence d_max will be small, and so will d_max-d_min.

To select the spurious lines, we use a thresholding procedure. Any line that has d_max-d_min<50 and d_max<50 will be classified as spurious and hence removed before step 25 is performed.

### 2.5 INDUSTRIAL APPLICABILITY

FIG. 13 showed that healthy and unhealthy images can be well-distinguished using the average of the length of all the lines in an image and the standard deviation of the lines. This, and the other experimental results given above, imply that the second embodiment can used as a successful tool for identifying subjects in these categories, even using a single ocular images. The subjects found to have unhealthy eyes can be subjected to further examination, or treated. It is known to treat patients with meibomian gland dysfunction with a warm compress with a hot towel, an eyemask, or a specialised heating device called blephasteam. In addition, anti-inflammatory medications such as doxycyclines, azithromycin and cyclosporin may be helpful. In addition, patients may be started on antibiotic steroid ointments topically. Off the counter lubricants, especially those containing lipids may be given to replenish the tear lipids, since there may be abnormal tear lipid layer in patients with this condition. Recent advances in this condition include mechanical probing of meibomian glands with or without intraglandular injection of steroids, as well as the in-office thermopulsation treatment called Lipiflow. As many of these treatments may be prone to poor compliance, or involve complications, or are expensive, it is helpful to have an objective means of diagnosing and evaluating meibomian gland dysfunction.

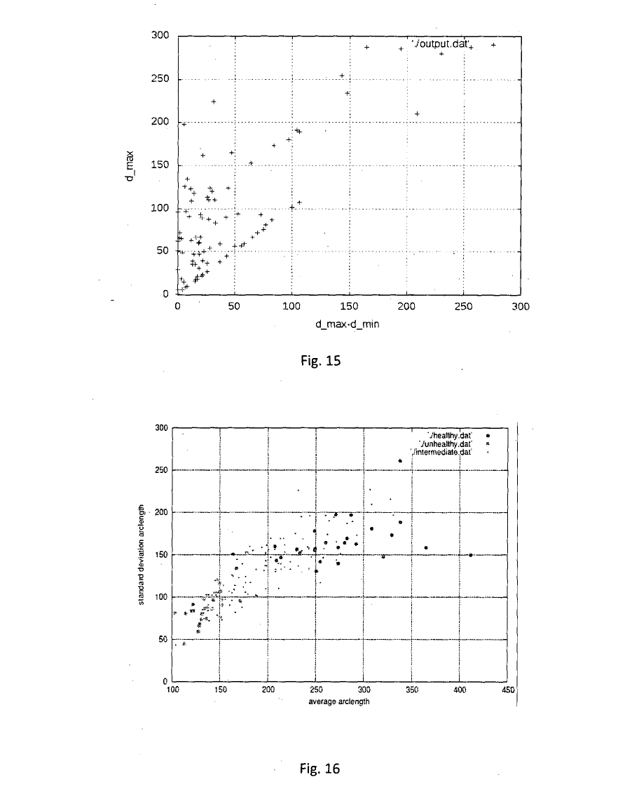

FIG. 16, which uses the same two features as FIG. 13 but also includes points for intermediate images shows that for these two features the intermediate grades overlap significantly with the healthy and unhealthy grades. Thus, it is desirable to use other features, such as the ones described above, to help distinguish the intermediate images. For example, it is intended to use the classifier described above for separating the healthy and unhealthy images to first give a preliminary classification of images into two classes (i) healthy/intermediate images or (ii) unhealthy/intermediate images. Specific features that distinguish between healthy/intermediate images can then be used to further separate the healthy from the intermediate class in the healthy/intermediate category. Similarly for the unhealthy/intermediate category.

### REFERENCES

[1] J. G. Daugman, “Uncertainty relation for resolution in space, spatial frequency, and orientation optimized by two-dimensional visual cortical filters,” J. Opt. Soc. Am. A, vol. 2, no. 7, pp. 1160-1169, July 1985.

[2] N. Petkov and P. Kruizinga, “Computational models of visual neurons specialised in the detection of periodic and aperiodic oriented visual stimuli: bar and grating cells,” Biological Cybernetics, vol. 76, pp. 83-96, 1997.

[3] P. Kruizinga and N. Petkov, “Nonlinear operator for oriented texture,” IEEE Transactions on Image Processing, vol. 8, no. 10, pp. 1395-1407, October 1999.

[4] D. G. Lowe, “Object Recognition from Local Scale-Invariant Features,” The

Proceedings of the Seventh IEEE International Conference on Computer Vision, vol. 2, pp. 1150-1157, 1999.

[5] A. I. Khinchin, Mathematical Foundations of Information Theory. Dover Publications, 1957.

[6] L. Lam, S. Lee, and C. Suen, “Thinning methodologies—a comprehensive survey,” IEEE Transactions on Pattern Analysis and Machine Intelligence, vol. 14, pp. 869-885, 1992.

[7] A. Niemisto, V. Dunmire, O. YIi-Harja, W. Zhang, and I. Shmulevich, “Robust quantification of in vitro angiogenesis through image analysis.” IEEE Transactions on Medical Imaging, vol. 24, no. 4, pp. 549-553, 2005.

[8] K. K. Nichols, G. N. Foulks, A. J. Bron, B. J. Glasgow, M. Dogru, K. Tsubota, M.

A. Lemp, and D. A. Sullivan, The International Workshop on Meibomian Gland Dysfunction: Executive Summary, Ophthalmol. Vis. Sci. Mar. 30, 2011 vol. 52 so no. 4 1922-1929.

1. A method performed by a computer apparatus for using an occular image of a region including meibomian glands to derive a grade indicative of the health of the meibomian glands, the method comprising:
(i) automatically obtaining one or more numerical parameters characterizing meibomian glands shown in the occular image;
(ii) automatically determining the grade using the one of more numerical parameters.

2. The method according to claim 1 in which said operation of obtaining the one or more numerical parameters comprises:
generating keypoints in the image, each keypoint being associated with a respective distance scale value;
obtaining one of said numerical parameters as a parameter indicative of the disparity of the scale values of the keypoints.

3. The method according to claim 2 in which said numerical parameter is calculated as an average over the keypoints of respective numerical value S, the numerical value S for each keypoint being calculated based on a sub-set of the other keypoints which are proximate the keypoint.

4. The method according to claim 3 in which the numerical value S is calculated according to the expression
$$S = - {\sum }_{i = 1}^{n} {p}_{i} ln {p}_{i} ,$$
where i=1, . . . , n labels the n keypoints of the subset, and pᵢ is given by
$${p}_{i} = \frac{{( {s}_{i} )}^{2}}{{\sum }_{i = 1}^{n} {( {s}_{i} )}^{2}}$$
where the sᵢ are the scale values of the n keypoints.

5. The method according to claim 1 in which at least one of said numerical features is derived by:
obtaining lines in the occular images indicative of the respective meibomian glands;
obtaining the at least one of the numerical features by measurement made using the lines.

6. The method according to claim 5 in which in which the operation of obtaining the lines in the images comprises:
extracting pixels that lie along bright and dark line regions of the image; and
grouping the pixels into clusters.

7. The method according to claim 6 in which the operation of obtaining the lines further comprises morphological operations on each cluster to form a line from the cluster.

8. The method according to claim 5 comprising a line exclusion operation of identifying ones of said lines which are not associated with glands, and removing them from consideration.

9. The method according to claim 8 in said line exclusion operation is performed by determining for each line the minimum distance d_min to a side of the image, and the maximum distance d_max to a side of the image, and identifying ones of said lines which are not associated with glands using said distances.

10. The method according to claim 9 in which the lines which are not associated with glands are identified as those for which d_max and d_max-d_min are below respective thresholds.

11. The method according to claim 5 in which the numerical parameters obtained using the lines, comprise any one or more of:
(i) the number of lines;
(ii) the total length of lines;
(iii) the average length of the lines;
(iv) the standard deviation of the lengths of the lines;
(v) a value obtained by, for a plurality of the lines, finding the sum along each line of a value obtained as a function of the distance of points on the line to points on another line;
(vi) a value obtained by, for a plurality of the lines, finding the sum along each line of a value obtained by measuring at least one distance, perpendicular to the tangent of the line, from the line to another said line; or
(vii) a value indicative of the ratio of the distance between the ends of the lines and the length of the corresponding lines.

12. A method of segmenting an ocular image of a region including meibomian glands, the method comprising:
at each of a plurality of locations in the image:
(i) subjecting the image to a Gabor function transform centred at the location, and characterized by at least a scale factor λ and a direction θ within the image;
(ii) summing the Gabor function transform over values of θ, to form an intensity value Î_{λ}; and
(iii) using Î_{λ} to perform a thresholding operation, to form a binary value representative of whether the corresponding location corresponds to the position of a meibomian gland.

13. The method according to claim 12 in which in operation (iii) the value Î_{λ} is summed over a plurality of values of λ, and the result is thresholded.

14. A computer apparatus for analysing an ocular image, the apparatus including a processor and a data storage device storing program instructions operative when performed by the processor to cause the processor to perform a method for using an occular image of a region including meibomian glands to derive a grade indicative of the health of the meibomian glands, the method comprising:
(i) automatically obtaining one or more numerical parameters characterizing meibomian glands shown in the occular image;
(ii) automatically determining the grade using the one of more numerical parameters.

15. A computer program product comprising program instructions operative when performed by a processor to cause the processor to perform a method for using an occular image of a region including meibomian glands to derive a grade indicative of the health of the meibomian glands, the method comprising:
(i) automatically obtaining one or more numerical parameters characterizing meibomian glands shown in the occular image;
(ii) automatically determining the grade using the one of more numerical parameters.
